(19) United States
(12) Patent Application Publication
(10) Pub. No.: US 2021/0231969 A1
(43) Pub. Date: Jul. 29, 2021

(54) Laser Projection Apparatus and Methods for 3-D Image Production

(71) Applicant: blisslights, llc, Oceanside, CA (US)

(72) Inventor: Randy Johnson, San Marcos, CA (US)

(21) Appl. No.: 17/228,255

(22) Filed: Apr. 12, 2021

Related U.S. Application Data
(63) Continuation of application No. PCT/US2019/056005, filed on Oct. 11, 2019.
(60) Provisional application No. 62/744,718, filed on Oct. 12, 2018.

(51) Int. Cl. G02B 30/54; G03H 1/22

(52) U.S. Cl. CPC G02B 30/54; G03H 2223/23; G03H 2001/2234; G03H 1/2205

(57) ABSTRACT

Disclosed herein is a consumer laser light device for producing laser light effects with the use of an optical effects wheel. In some respects, the disclosure is direct to a device for selectively providing one of multiple optical effects manipulating a laser beam, including an optical effects wheel positioned in the light path, the optical effects wheel having a first optical effect engraved on a first portion of the optical effects wheel and a second optical effect engraved on a second portion of the optical effects wheel, wherein the first portion and the second portion partially overlap. The optical effects wheel may be further modified to ensure that the device complies with consumer safety requirements for laser light devices.

### TECHNICAL FIELD

The technical field of art is laser light projection displays. More particularly, the apparatus and methods disclosed relate to the production of three-dimensional (3D) laser light displays such as those produced at laser light shows.

### BACKGROUND ART

To create the 3D light displays common in laser light shows, laser light beams are typically steered by movable mirrors mounted to galvanometers. Galvanometer-mounted mirrors may be rotatable in one or two dimensions and may be mounted on a track. For laser light shows, two-dimensional galvanometers, also known as X-Y scanners, are typically used. The laser light is displayed through a particulate such as glycol, oil, or water released by a heat or air compressed fogging machine into the atmosphere.

However, galvanometers for use with laser light shows and projection are typically very expensive and beyond the means of an individual consumer. Additionally, the laser energy must be maintained at or below certain governmentally mandated energy density levels when used for audience scanning Galvanometers accordingly must produce strong and accurate laser effects while also reducing the potential eye injuries caused by very bright laser light.

What is needed, then, is a laser light projection system capable of producing 3D laser light displays without the cost and complexity of an X-Y galvanometric scanner apparatus along with associated Laser safety compliance systems.

### SUMMARY OF THE INVENTION

In some respects, the disclosure is direct to a device for selectively providing one of multiple optical effects manipulating a laser beam having a laser light source capable of directing a beam of light along a light path; a stationary holographic optical element in the light path; a motor comprising a rotary shaft; an optical effects wheel pinned to the rotary shaft and arranged such that the optical effects wheel is positioned in the light path, the optical effects wheel having a first optical effect engraved on a first portion of the optical effects wheel and a second optical effect engraved on a second portion of the optical effects wheel, wherein the first portion and the second portion partially overlap; and a power source for providing power to operate the laser light source and the motor.

### BRIEF DESCRIPTION OF DRAWINGS

FIG. 1 is an exterior view of an apparatus according to one embodiment of the disclosure.

FIG. 2 is a view of the laser, motor, wheel, and circuit board according to one embodiment of the disclosure.

FIG. 3 is a view of a wheel showing different domains according to one embodiment of the disclosure.

### DESCRIPTION OF EMBODIMENTS

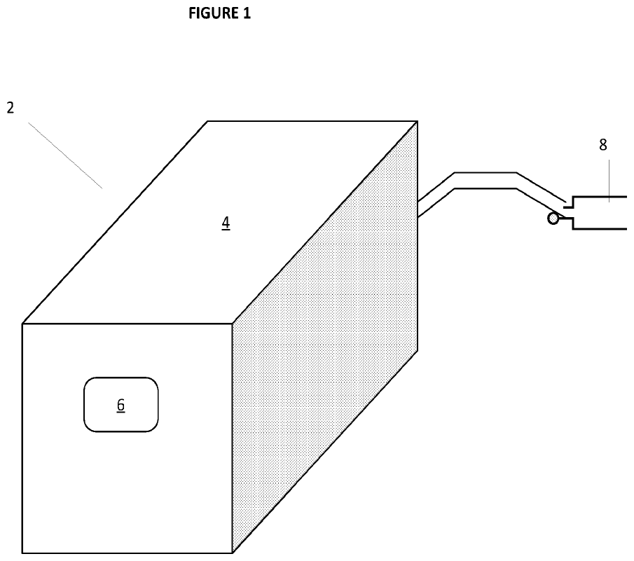

FIG. 1 depicts the components of a laser projection system 2 according to one embodiment of the invention. The projection system 2 includes an enclosure 4. In some embodiments, the enclosure 4 may be mounted to a base (not shown). The base may provide stability to the enclosure for maintaining a consistent lighting display. The enclosure 4 may be fully or partially enclosed. As depicted in FIG. 1, the enclosure 4 has a top wall, a bottom wall, and two side walls. The enclosure 4 may include a front wall with an aperture permitting the laser light to pass through the aperture for display. A transmissive optical element 6 may be placed across the aperture. An optical element is a material that manipulates light, such as a lens, interference filter, diffraction grating, or beam splitter. Other optical elements may be used as well. The enclosure may also have a back plate or covering. The front cover, back plate, and any other removable portions of the enclosure may be attached with screws, bolts, adhesive, or other mounting mechanisms. These removable parts may also include a gasket to prevent moisture from entering the enclosure.

A power supply 8 is also provided. The power supply may be provided externally or internally. An external power supply, for example, may be a cord allowing for plugging into a standard electrical socket or connecting to some other external battery, generator, or power source. Alternatively, the power supply may be provided internally, such as a battery. If the power supply is external and the housing is fully enclosed, the power supply may plug into an electrical connection or socket on the enclosure. As depicted in FIG. 1, the power supply is a cord and the back plate includes an electrical socket and internal connections.

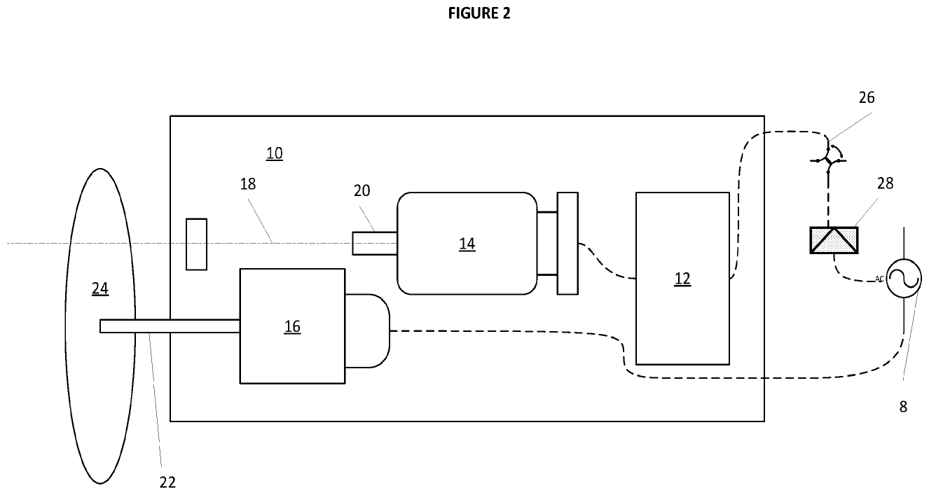

FIG. 2 shows a schematic of the internal components of a system 2 according to one embodiment. The back enclosure has a power jack on the external side for receiving a power cord, and which is shown in FIG. 2 as an AC power source 8. On the internal face of the back plate is wiring connecting the various parts of the apparatus. Other wiring connects to user controls on user controls on the external face of the back plate. The wiring shown in FIG. 2 is further described below.

In some embodiments within the enclosure is situated a board 10. The board 10 provides a place for mounting various other components of the apparatus. A circuit board 12 may be mounted to the board. A laser module 14 may be mounted to the board. A motor 16 may be mounted to the board. All of these components are shown mounted to the board in the embodiment depicted in FIG. 2. The circuit board 12 includes a driver circuit for providing electrical power to the laser module 14 and to the motor 16.

The laser module 14 includes a laser and collimating optics. The laser is directed to emit a beam of light along a light path 18 from one end of the laser module 14 when provided power. The laser module 14 may also hold one or more optical elements 20 within the light path 18 of the laser beam. The laser module 14 is mounted to the board 10 such that, when installed within the housing 4, the light path 18 of the beam emitted by the laser module 14 passes through the aperture in the housing 4 and optical element 6, if such a housing and/or optical element are provided.

The motor 16 is attached to and drives a rotating shaft 22. Connected to the end of the rotating shaft 22 is an optical effect element, such as a transmissive, reflective interference wheel 24 or other diffractive optical element. As shown in FIG. 2, the wheel 24 is positioned such that a portion of the wheel 24 passes across the light path 18 of the emitted light beam from the laser module 14. The wheel 24 and the wheel's design and fabrication are described further below.

A diffractive optical element, such as the wheel 24 shown in FIG. 2, is a type of optical element that manipulates light on the principle of diffraction. Traditional optical elements use their geometric shape to refract light. By contrast, diffractive optics use constructive and destructive interference to cause the electromagnetic aspect of waves of light to recombine into a larger number of waves which then recombine to form completely new wave sets. Diffractive optical elements may include diffraction gratings or a pre-defined lens functions. Diffractive optical elements can be fabricated in a wide range of materials including, but not limited to, aluminum, silicon, fused silica or plastic.

Holography is a technique that allows the light scattered from an object to be recorded and later reconstructed so that it appears as if the object is in the same position relative to the recording medium as it was when recorded. The image changes as the position and orientation of the viewing system changes in the same way as if the object were still present, thus making the recorded image, termed a hologram, appear three-dimensional. A hologram can be produced from laser-light beams being back scattered from an object and interfered with by a frequency stabilized reference beam. A two-dimensional recording medium, such as a photosensitive plate or holographic film, records three-dimensional volumetric phase information of an object which is termed a fringe or iterative Fourier transfer algorithm (IFTA) pattern. This procedure is like photography where white light scattered from photographed objects is recorded on silver halide film. Light embodies the property of transverse phase (volume) and photon population density (intensity) but only intensity is recorded in conventional photography. A hologram, however, stores both amplitude and phase due to the interference of the reference beam. This reference beam possesses the same characteristics as scattered light because of the action of the laser. The phase information is the most important factor in holography because it provides the depth cues to the eyes and allows for an image to appear in three dimensions.

Another method of creating a holographic image may be performed a computer numerically simulating the physical phenomena of light diffraction and interference. It is possible for computer software to calculate the phase of light reflected or transmitted from or through an object. Computing the phase of light of different objects, such as points, lines and wire frames, produces an interferential simulation that may in turn by transferred to a photographically sensitive media or written to a photo-resist coated silicon wafer using an E-beam method.

A holographic optical element is a type of diffractive optical element. A holographic optical element is a hologram of a point source and acts as a lens or a mirror having optical power, i.e., the ability to focus light. The hologram consists of a diffraction pattern rendered as a surface relief which may be, for example, a thin film (created using photoresist and/or dichromate gelatin) containing an index modulation throughout the thickness of the film. “Index modulation” refers to a periodic feature set that has a linear distribution of patterns to produce novel optical effects created during the process of making the holographic optical element. Either process (dichromate gelatin or photoresist) can be used to create a mathematical distribution to create a linear derivative producing a periodic feature set implemented into a phase mask. In one embodiment of the invention, a non-linear implementation of IFTA produces a logarithmic or otherwise hyperbolic IFTA wave function that may be used to produce nonlinear phase derivatives onto a diffractive surface. A in some embodiments, holograms can be classified into two categories: (I) “reflective” holograms in which incident and diffracted light are on the same side of the holographic optical element; and (ii) “transmissive” in which incident and diffracted light are on opposite sides.

Returning to the schematic depicted in FIG. 2, several user controls may be provided. These may be provided on the external face of the back plate or on other external surfaces of the housing 4. For example, one control may be an on/off switch 26 to control the laser. Another control may be a modulator 28 for increasing or decreasing the speed of motor 16 rotating the wheel 24. Other controls may also be provided that control or manipulate other mechanical or optical characteristics of the apparatus.

The optical effect wheel 24 may include one or more optical elements arranged in domains on the face of the wheel. The optical effect provided in each of the one or more domains on the wheel may embody a plurality of optical effect elements, i.e., diffractive optical elements, interference producing features that refract, reflect, transmit, diffract, or otherwise create visual effects through direct interaction with a coherent light source such as a laser. In one embodiment, the optical effect may be similar to that of a laser using a galvanometric scanner, such that a 3D effect may be provided when the laser beam is shown through an atmospheric particulate.

The optical effect wheel 24 is fabricated using a combination of technologies to produce the desired effect. More specifically, a domain is the interference product of two or more light patterns applied to a portion of the wheel. The first interference pattern is a holographic image. The holographic image may be any desired image or design. A holographic image is a photographic recording of a light field created by preserving the interference pattern created by a reference laser beam and the object beam produced by a reflection off an object that is being recorded. The interference pattern is recorded on a recording medium (e.g., a photo sensitive plate or film).

The second or additional light patterns on the wheel may be produced from a metallic surface engraved using a diamond turning machine tool from which a “master” engraving may be produced. In some embodiments, the engravings may be approximately 1 micron deep. In other embodiments, the engravings may be approximate 0.5-10 microns deep. The selected engraved pattern may be any desired engraving pattern. In some embodiments, the engraving pattern may be a line or pattern that is the result of applying an inverse Fourier transform algorithm a desired curve or shape. In such embodiments, the desired curve or shape is thereby encoded in the design, with the result that by applying the interference lighting techniques described herein, the coded pattern on the engraving results in the desired curve or shape being displayed. The master engraving may be formed from a selected substrate which is electroplated with an appropriate metal suitable for engraving, such as chromium metal. Once the master is created, a holographic monomer, such as photopolymers produced by DuPont® or 3M®, may be applied to the engraved master to receive the pattern on the surface of the engraved master. This monomer may be cured to create a “replicate” which matches the engravings on the engraved master and may be used to create a replicate of the desired lighting effect based on the engraving.

To produce the domain on the wheel, a frequency stabilized laser beam is directed through each of the holographic elements and the replicate produced from the metal graving. The laser beam is directed onto another photographic plate or film to create an interference pattern as a product of the two or more effects, and which may be recorded onto a plate or film. This interference pattern is recorded onto a photo sensitive medium film such as dichromate gelatin, to generate another “master” pattern whereas replicates may be produced from this second master. This image may be developed onto a variety of mediums including film or photo-sensitive material that is replicated using a holographic monometer which is cured by using UV light source which may be applied directly or embossed onto the wheel in the desired location.

Where more than one domain is present on the wheel, domains may be overlapped and inter-modulated to allow for smooth visual transitions between the two domains. For example, the amplitude of a first domain may decrease over a particular space such that the image fades out as the laser light passes across that portion and moves away from the primary area of the domain. In contrast, the second domain may increase in amplitude, such that it fades in and becomes the primary image.

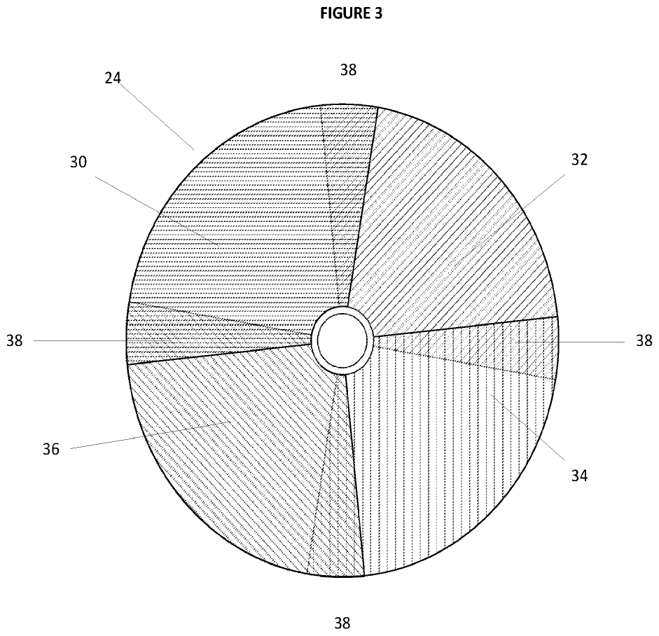

FIG. 3 shows an optical effects wheel with domains laid out on portions of the wheel, according to an embodiment of the invention. The wheel has domains 30, 32, 34, and 36, each laid over approximately one quarter of the wheel's surface area. Each domain has a small area of overlap 38 with the domain arcuately adjacent to it. In these overlapped areas 38, the amplitude of the optical effect of one domain diminishes as the amplitude of the optical effect in the adjacent domain increases. Thus, when the wheel rotates such that the laser light passes from one domain to the next, the first effect fades out of view while the second effect becomes more and more visible.

One issue with the use of the effects wheel is that it has irregular surface patterns, which can result in splitting and recombining laser light at intensities or energy levels that exceed permissible laser power levels for consumer electronics. For example, the American National Standards Institute defines a Class 2 laser, which is considered safe for most purposes, as a continuous visible light laser beam at 1 mW power or less. A class 3R laser beam, which may be handled carefully with restricted viewing, is defined as a continuous visible light laser beam having between 1.0 and 4.99 mW power. For consumer use, the laser light effects must be created in a way that maintains the laser energy in compliance with such requirements.

One mechanism for doing this is to provide quasi-random, non-periodic relief topological features onto one or both sides of a wheel. The relief structures are implemented as surface features which are irregular in nature with respect to density, height, depth, shape, distribution of various spatial distribution, wheel surface flatness variation, material optical properties with respect to degree of optical transmission, reflectivity, diffusion, dichroic wavelength selective coatings etc. These variations in the surface topology of the wheel result in scattering the laser light or diffracting the light in the many more diffractive orders, thereby reducing the intensity of the light.

Another mechanism for reducing or maintaining laser energy at levels acceptable for consumer use is using a diffraction grating in the path of the light. The diffraction grating causes the primary laser beam energy to be distributed into lesser power diffracted orders. The diffracted energy orders together are approximately equal to the original non-diffracted laser beam's energy, minus any energy absorption attributable to the diffraction grating and the optical effects wheel. The diffraction grating may be stationary or moving, such as an interferential wheel. The diffracted light may then be directed onto the optical effect wheel which may also be stationary or moving to further diffract or scatter the light.

Another mechanism for reducing or maintaining laser energy at levels acceptable for consumer use is to increase the divergence angle of the collimated laser beam incidental to the surface of the optical effects wheel. This increases the cross sectional area of the laser beam on the wheel, resulting in a wider distribution of the light beam energy and a corresponding reduction of energy at any given point. The subsequently refracted or diffracted light scattered from the optical effects wheel is also correspondingly reduced. For example, in a certain configuration the optical effects wheel is placed perpendicular to the light path laser light beam, and the divergence angle is . In that configuration, the maximum power of a laser light beam passing through the various optical effects is 2 mW, but it is desired to reduce the maximum power to below 1 mW, such that the device is classified as a Class 2 laser. To achieve this, the laser's angle of divergence may be increased by a factor of the square root of 2 (i.e., ˜1.414) which will have the effect of doubling the surface area of the laser beam when it strikes the optical effects wheel and correspondingly reducing the power of the laser.

It is to be understood that the embodiments and descriptions herein are exemplary only, and that a person of ordinary skill may use the teachings and descriptions herein to achieve the same or similar effects. Accordingly, the scope of this disclosure shall be defined by the claims that follow.

I claim:

1. A device for selectively providing one of multiple optical effects manipulating a laser beam comprising:
a laser light source capable of directing a beam of light along a light path;
a stationary holographic optical element in the light path;
a motor comprising a rotary shaft;
an optical effects wheel pinned to the rotary shaft and arranged such that the optical effects wheel is positioned in the light path, the optical effects wheel having a first optical effect applied to a first portion of the optical effects wheel and a second optical effect applied to a second portion of the optical effects wheel, and including an area where the first portion and the second portion partially overlap; and
a power source for providing power to operate the laser light source and the motor.

2. The device of claim 1, wherein the first optical effect is engraved onto the wheel at a depth of 0.5 to10 microns.

3. The device of claim 2, wherein the first optical effect is engraved onto the wheel at a depth of 1 micron.

4. The device of claim 1, wherein in first portion and the second portion have varying engraving depths in the area where the first portion and the second portion partially overlap.

5. The device of claim 1 wherein the first optical effect is a hologram.

6. The device of claim 1 wherein the first optical effect is a combination of a hologram and an engraving on the first portion of the wheel.

7. The device of claim 1 wherein the optical effects wheel comprises a quasi-random, non-periodic relief topological feature.

8. The device of claim 1, further comprising a diffraction grating in the light path between the laser light source and the optical effects wheel.
